(19) United States
(12) Patent Application Publication
(10) Pub. No.: US 2002/0059250 A1
(43) Pub. Date: May 16, 2002

(54) Character information search system and search method

(76) Inventors: Kiyoshi Arai, Atsugi-shi (JP); Tsuneo Nishioka, Tokyo (JP); Masabumi Okaga, Tokyo (JP)

Correspondence Address: JENKENS & GILCHRIST, PC, 1445 ROSS AVENUE, SUITE 3200, DALLAS, TX, 75202, US

(21) Appl. No.: 09/915,954

(22) Filed: Jul. 25, 2001

(30) Foreign Application Priority Data
Jul. 28, 2000 (JP) 2000-229193

(51) Int. Cl. G06F 7/00

(52) U.S. Cl. 707/10

(57) ABSTRACT

In a character information search system including a plurality of information processing terminals 101a-101n used in a plurality of predetermined organizations and a management center 103, the number of organization to which a character to be searched is belongs is retrieved based on character information contained in a search request sent from one of the information terminals 101 through a network, according to the retrieved organization number, the information is translated into an address of a location in a database in the management center 103 corresponding to the character to be searched, and character information about the character to be retrieved stored at the translated address in the database is output to the information processing terminal 101.

### BACKGROUND OF THE INVENTION

The present invention relates to a character information search system and search method.

Recently, as the Internet has become widespread, a user of the Internet has become able to use software such as a Web browser installed on a personal computer (PC) to browse Web sites and pages on the Internet.

The Internet is available to people all over the world and if Internet users in Western countries in which Roman alphabets are used browses a Web site or page written in a kanji (Chinese character) or Arabic character code (including external characters), the characters would become garbled and cannot displayed properly without an appropriate font being installed onto the computer.

Because the computer was first developed in the United States, character codes used within the computer is Roman-alphabet-based and it is impossible for the fonts of character codes (including external characters) associated with all of the languages of the world to be preinstalled onto the computer. In addition, some Western alphabets may vary in form among English, German, French, and Russian.

Therefore computer manufacturers have to make provision for allowing the fonts of a character code associated with a language used to be installed in a computer when a user purchases the computer.

In today's computer world, engineers are going to replace character codes with a global standard character code called “Unicode”. However, even Unicode cannot support all of the languages of the world.

In addition, in kanji systems used in personal computers (PCs) and workstations (WSs) built by different computer manufacturers, characters (external characters) other than those of character codes defined by the JIS (Japanese Industrial Standards) are not compatible with each other.

Therefore different computer systems used in institutes, organizations, and companies use different character (kanji) code processing systems and document processing among them is not unified. That is, there are the following problems:

(1) computer processing relating to characters (kanji) other than the JIS code characters is not unified and is performed manually;

(2) an inter-company translation system cannot be implemented because of companies' expectations in unified processing of the characters (kanji) other than JIS code characters; and

(3) while everyone wants the implementation of a unified translation system, no one has tackled it yet.

### SUMMARY OF THE INVENTION

The present invention has been made to solve these problems and it is an object of the present invention to provide a character information search system and search method that improve user's convenience by constructing a search system for a dictionary database and a character code system and enabling a plurality of users to share the system,

It is another object of the present invention to provide a character information search system and search method that eliminate the need for computer manufacturers to provided a font supporting any character and reduce the costs of a computer, by constructing a database of MJ letters that can represent any characters and the search system on a server on the Internet to make available them to a number of users.

It is another object of the present invention to provide a character information search system and search method, wherein the sender has no limitations (for example the prohibition of the use of external characters) to characters used for writing a document and the receiver of the document can use a character code system search system to display or print the document properly.

In order to achieve these objects, according to an aspect of the present invention, a system for providing a search service for searching a desired character to a plurality of users through a network, the system comprising:

a database storing character information corresponding to a plurality of characters;

means for retrieving search information about a search character to be searched sent from a user through a network;

address determination means for determining an address of a location in the database based on the retrieved search information; and

means for providing character information stored at the determined address of the location in the database through the network is provided.

According to another aspect of the present invention, a search method for providing a search service for searching a desired character to a plurality of users through a network, the method comprising the steps of:

retrieving search information about a search character to be searched sent from a user through the network;

determining an address of a location in a database storing character information corresponding to a plurality of characters based on the retrieved search information; and

providing character information stored at the determined address of the location in the database through the network is provided.

According to yet another aspect of the present invention, a program for search method in a system for providing a search service for searching a desired character to a plurality of users through a network, the program comprising codes for the steps of:

retrieving search information about a search character to be searched sent from a user through the network;

determining an address of a location in a database storing character information corresponding t o a plurality of characters based on the retrieved search information; and

providing character information stored at the determined address of the location in the database through the network is provided.

Other objects of the present invention will be apparent form the accompanying drawing and detailed description that will be provided below.

### BRIEF DESCRIPTION OF THE DRAWINGS

FIG. 1 shows a general configuration of a character information search system according to an embodiment;

FIG. 2 shows network terminal group consisting of a plurality of kanji systems;

FIG. 3 shows a general configuration of a management center shown in FIG. 1;

FIG. 4 shows a diagram for illustrating a translation algorithm 301 shown in FIG. 3;

FIG. 5 shows memory space in a database 302 shown in FIG. 3;

FIG. 6 shows an address representation of an MJ letter according to the present system;

FIG. 7 shows a concept for adding an MJ letter to an address space in the database 302;

FIG. 8 shows a configuration of a character information block according to the embodiment;

FIG. 9 is a flowchart of a procedure for adding (deleting) a character (kanji);

FIG. 10 is a diagram for illustrating a method for searching for the MJ letter according to the embodiment;

FIG. 11 shows a result of a search for related characters based on a specified code;

FIG. 12 shows a result of a search for characters relating to a Chinese-style reading based on the Chinese-style reading specified as an attribute;

FIG. 13 shows a result of a search for characters relating to a Japanese-style reading based on the Japanese-style reading specified as an attribute;

FIG. 14 shows a result of a search for characters relating to a radical based on the radical specified as an attribute; and

FIG. 15 shows a result of a search for characters relating to the number of strokes based on the number of strokes specified as an attribute.

### DETAILED DESCRIPTION OF THE PREFERRED EMBODIMENT

An embodiment of the present invention will be described below with reference to the accompanying drawings.

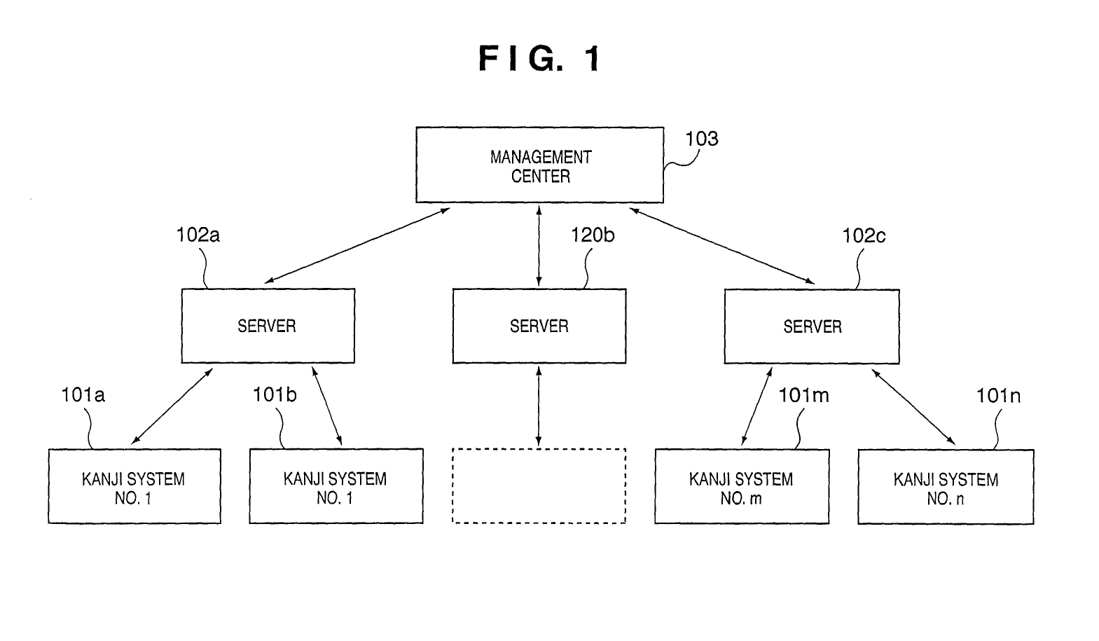

FIG. 1 shows a general configuration of a character information search system according to the present embodiment. Reference numerals 101a, 101b, . . . , 101m, 101n in FIG. 1 denote a terminal kanji systems, which may be personal computers (PCs) or workstations (WSs) used for document processing in institutes, organization, and companies interconnected over a network such as the Internet and an intranet. Reference numerals 102a, 102b, and 102c are network servers (hereinafter refers to as “servers”), which enable access to a management center, which will be described later, independent of the type of the terminal kanji system 101 and provide a security function in the network. Reference numeral 103 denotes a management center, which centrally processes nonstandard characters, that is, characters (kanji) belonging to different systems, besides character (kanji)s processed by the terminal kanji system 101.

The configuration of the terminal kanji systems 101a, 101b, . . . , 101m, 101n is not limited to the one shown in FIG. 1.

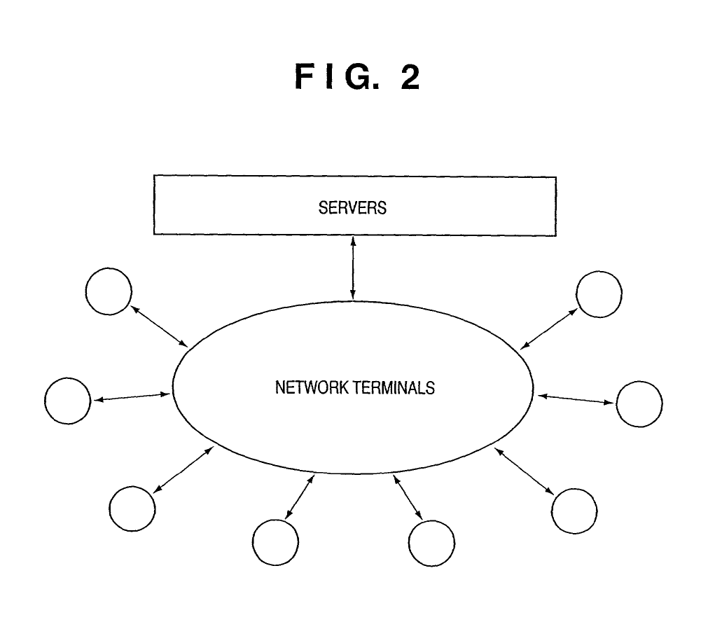

A plurality of kanji systems may be configured as a group of network terminals as shown in FIG. 2.

In addition, a server for providing a text search service to users may be built; the server may provide a Web site may be provided on he Internet to make the service it to companies and individual users. In this case, a user can display the search service site through a Web browser on a personal computer (PC) and enter search information about a character he/she wants to find to obtain character information corresponding to that character and display or print it. A charging system for the search service is used under the management of a service provider providing connections to the Internet.

An existing communications protocol using packet exchanging conforming to the OSI reference model is used for communications between the terminal kanji system 101 and the management center 103.

The configuration and operation of the management center 103 according to the present embodiment will be described below.

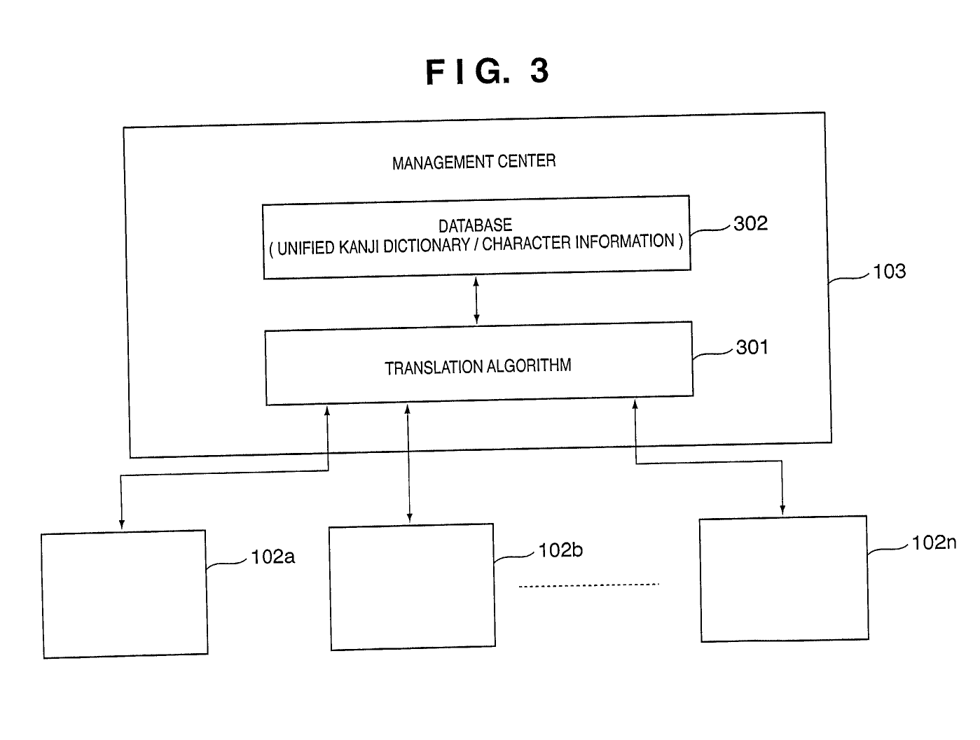

FIG. 3 shows a general configuration of the management center shown in FIG. 1. Reference numeral 301 in FIG. 3 denotes a translation algorithm for performing address translation, which will be detailed later, to translate an address to a unified character information address of a memory space in the database based on a search request for a search character sent from the terminal kanji system 101 through the server 102. Reference numeral 302 denotes a database in which a unified character (kanji) dictionary/character information or the like, which is character information placed in a given memory space and supports any characters (standard and nonstandard characters), is constructed.

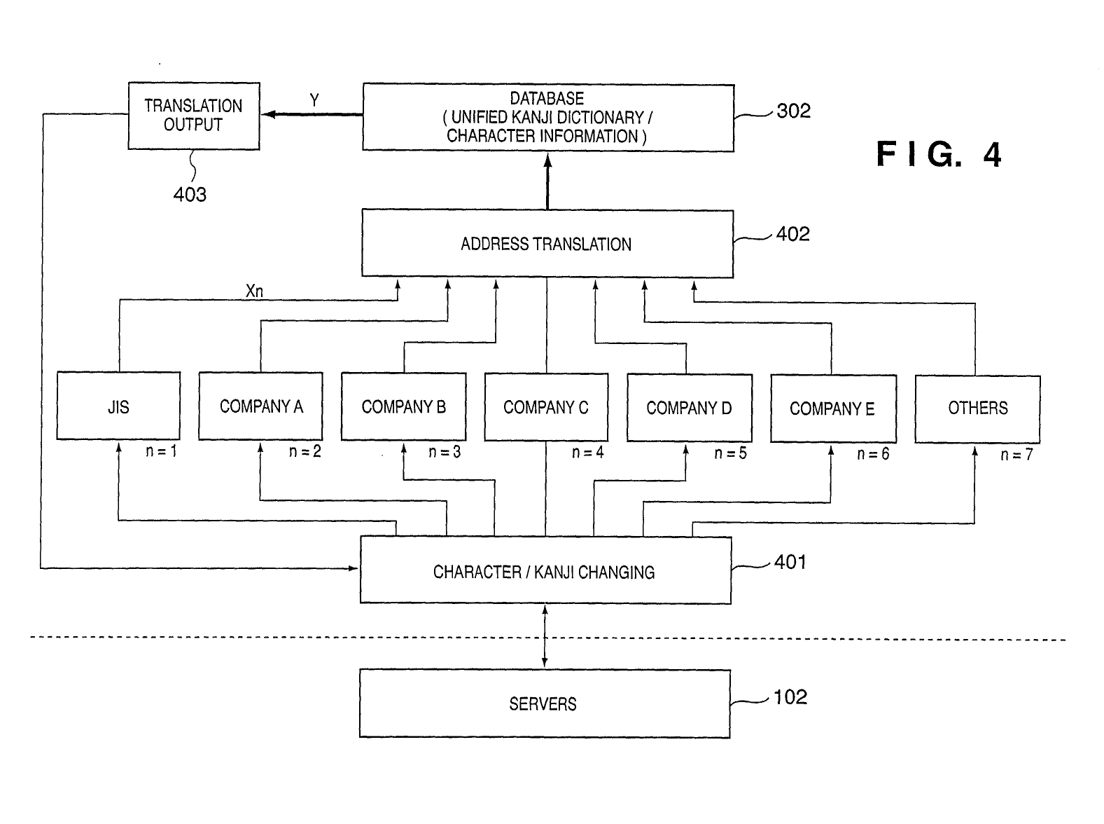

FIG. 4 is a diagram for explaining the translation algorithm 301 shown in FIG. 3. Reference numeral 401 in FIG. 4 denotes a character kanji group changing module for changing a search request for a character sent from a terminal kanji system (101, for example) through the server 102 to one in a translated code system Xₙ. Reference numeral 402 denotes an address translation module for translating an address in the translated code system Xₙ into address Y in the unified representation kanji dictionary. Reference numeral 403 denotes a translation output module for outputting character information at address Y in the unified representation kanji dictionary from the database 302.

That is, translation method performed by the address translation module 402 according to the present embodiment is an algorithm that relates unified representation kanji code Y to translated code system Xₙ in a one-to-one correspondence as expressed by the following equation:

Y=Fₙ(Xₙ)

where n corresponds to a code in an example shown in FIG. 4 as follows:

n=1: JIS code

n=2: code of company A

n=3: code of company B

n=4: code of company C

n=5: code of company D

n=6: code of company E

n=7: other codes.

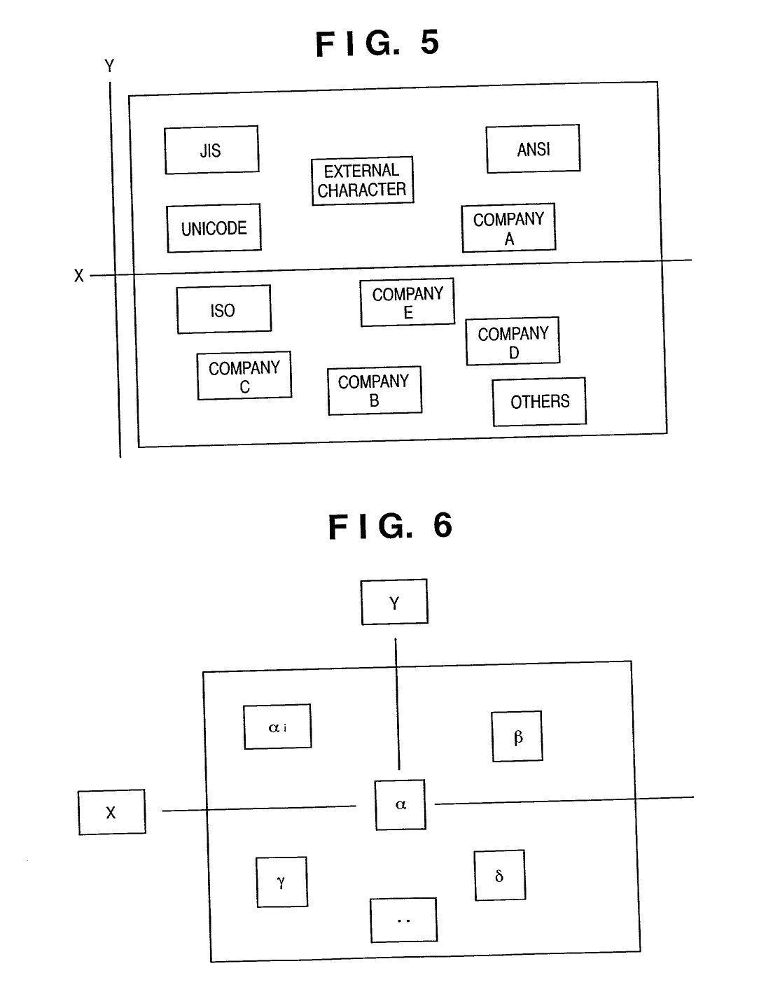

FIG. 5 shows the memory space in the database 302 shown in FIG. 3. While the memory space in the present embodiment is a finite space in reality, it maybe assumed as an infinite space in theory, of course.

As shown in FIG. 5, any characters (standard and nonstandard) is placed at a given address. In addition, any nonstandard (external character) code can be added. Any newly added nonstandard character (kanji) is represented in an MJ letter, which will be described later.

FIG. 6 shows an address representation of the MJ letter according to this system. As shown in FIG. 6, even an only slightly deferent character in the MJ letter in this system is considered to be a different character style, a number is assigned to it, and placed at a given address. The MJ character style is different from a coding format that represents a character within a framework of a limited number of bits, such as 8×8, 16×16, or 32×32 as in a conventional character code. The MJ character style is simply recognized as a number.

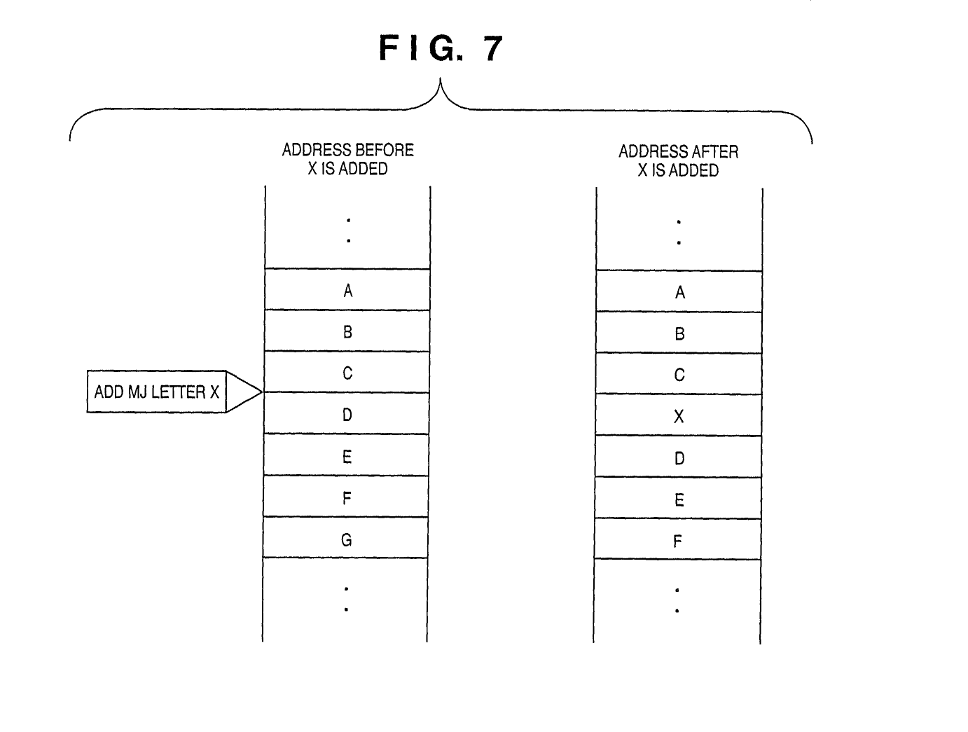

FIG. 7 shows a concept for adding an MJ letter into an address space in the database 302. When an MJ letter “X” is added into an address at which an MJ letter has already been entered in the example shown in FIG. 7, it is added to the address of MJ letter “D” and all of the subsequent addresses are changed. Thus, related MJ letters can be entered in the adjacent address spaces and therefore the time required for searching for an MJ letter can be reduced.

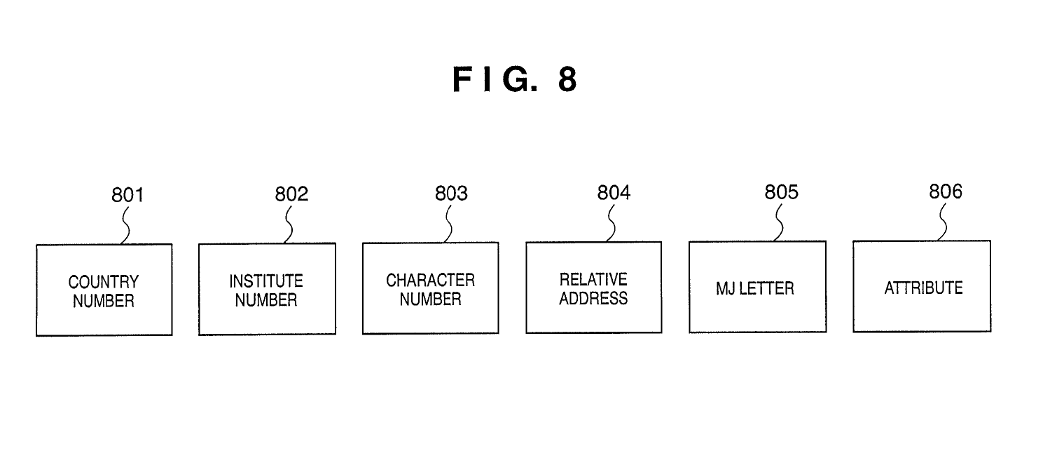

In the present embodiment, it is assumed that all the characters including MJ letters are entered in the database 302 of the management center 103 beforehand and are to be distributed for pay to a user as a code book represented by code blocks as shown in FIG. 8.

In FIG. 8, Reference numeral 801 denotes a country number represented like: Japan=1, China=2, Korea=3, Taiwan=4, . . . Reference numeral 802 denotes an organization number corresponding to n in the equation provided above. Reference numeral 803 denotes a character number added by each country or organization. Reference numeral 804 denotes a relative address, which is an address of an MJ letter placed in a database in a different organization, and Reference numeral 805 is an MJ letter, which is an unified address to which a character is translated into. Reference numeral 806 is a an attribute representing Chinese-style reading, Japanese-style reading, radical, the number of strokes, character style, and typeface.

While each code block consists of 1024 bits and six blocks form one group in the present embodiment, construction is not limited to this.

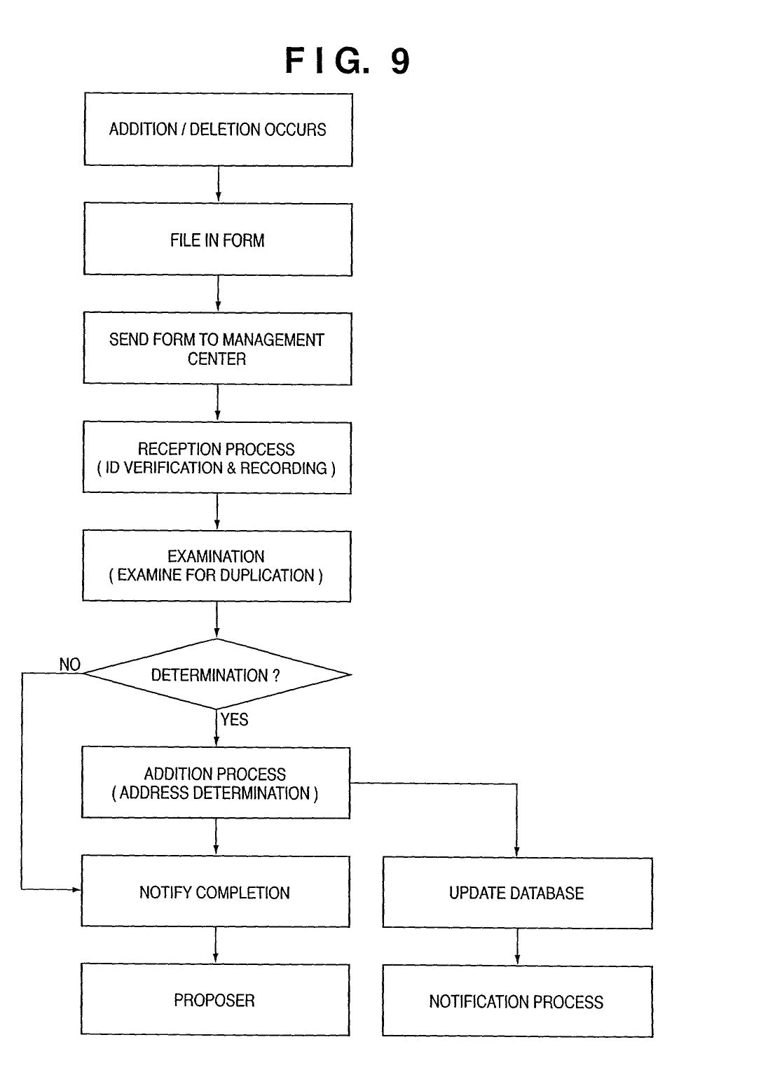

In addition, addition (deletion) of a character to the database 302 of the management center 103 may be performed by a proposer sending the character (kanji) to be added (deleted) to the management center 103 through each terminal kanji system 101 according to a predetermined form. Alternatively, the addition (deletion) maybe performed by regular mail, facsimile, or e-mail as shown in FIG. 9.

When a request for addition (deletion) is provided to the management center 103, the ID of the proposer is verified and recorded in a reception process in an example shown in FIG. 9. Then the character to be added (deleted) is examined according to predetermined criteria and the database is examined for its duplication. If the result of the examination is “OK”, the character is added to the database and the proposer is informed of the addition. If the result is “NG”, the proposer is informed of the reason for the result.

Now, a method performed by a user of a terminal kanji system (for example 101 shown in FIG. 1) for searching a desired MJ letter in the character information search system will be described.

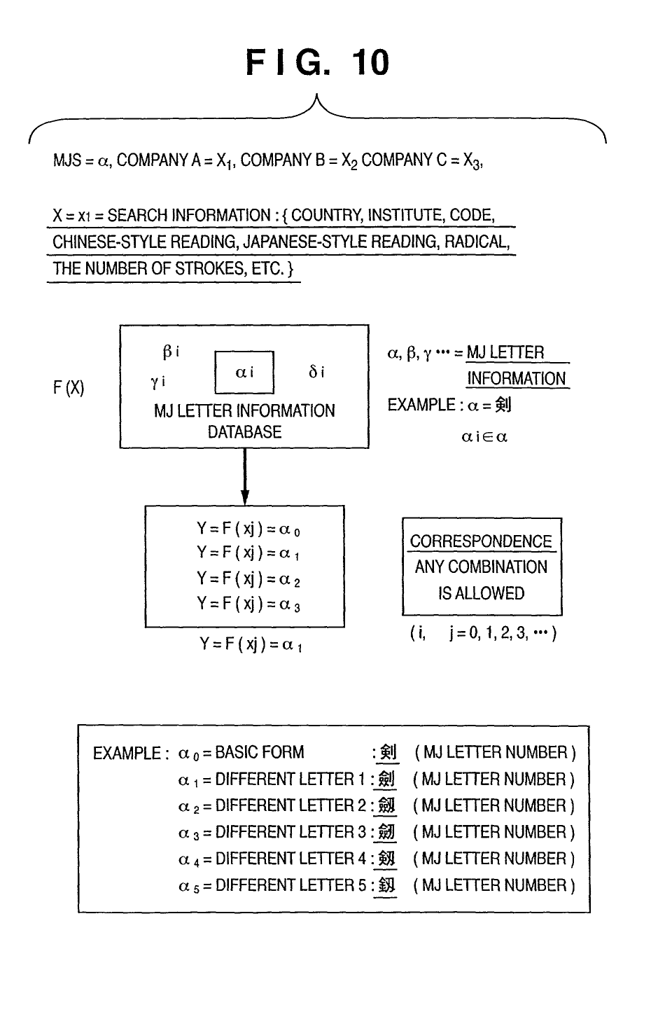

FIG. 10 illustrates the method for searching an MJ letter in the present embodiment. In the example shown in FIG. 10, an MJ letter (α) to be searched for is “ [symbol] ” and the organization is “JIS”. First, when a request for searching the MJ letter is sent from the user of the terminal kanji system 101 through a server 102, a translation algorithm 301 in a management center 103 determines, based on an organization number (n) contained in the sent data string, which character group the MJ letter to be searched for belongs to. Then the translation equation provided above is used to translate it into an address of a corresponding MJ letter placed in a memory space of the database 302 and the MJ letter found is sent from the database 302 to the terminal kanji system 101 that searched for the MJ letter through a translation output module 403.

It is assumed that characters similar to that MJ letter has already been entered in organizations (for example, JIS, ISO, ASCII, Unicode, Japanese EUC and characters specific to individual companies) and all of the related characters are provided to the searcher in response to a search request and a letter (skeleton representation) information for the a character selected from them is provided as the output data.

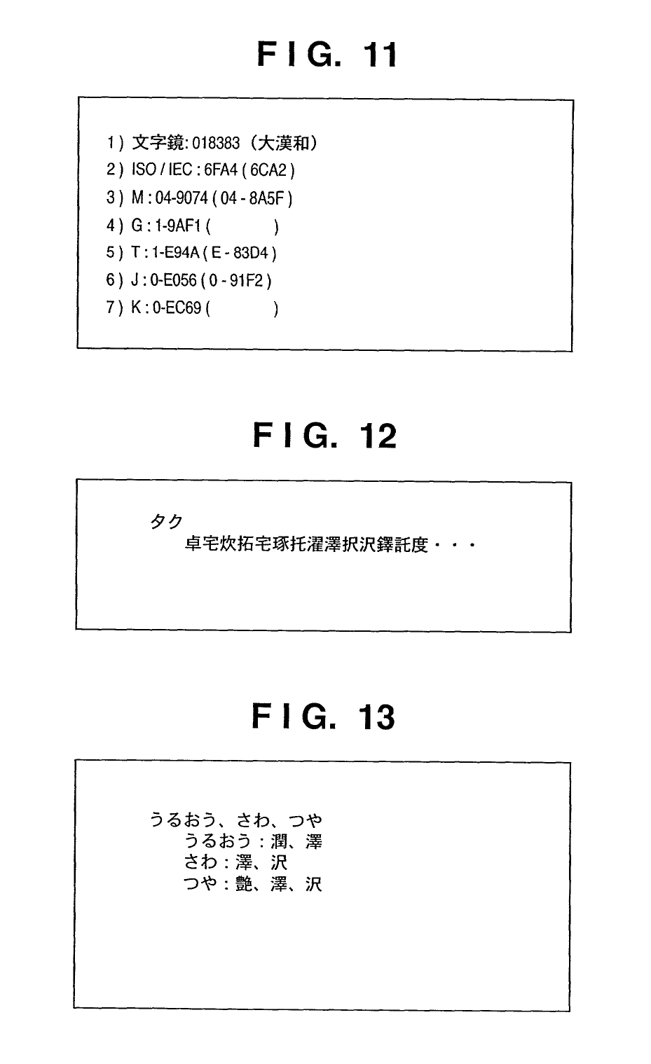

FIGS. 11 through 15 show search results displayed on the display of the terminal kanji system by the character information search system according to the present embodiment. In this example, a search character, “ [symbol] (Chinese character), simplified form: [symbol] (017234)” in the code blocks shown in FIG. 8 is specified.

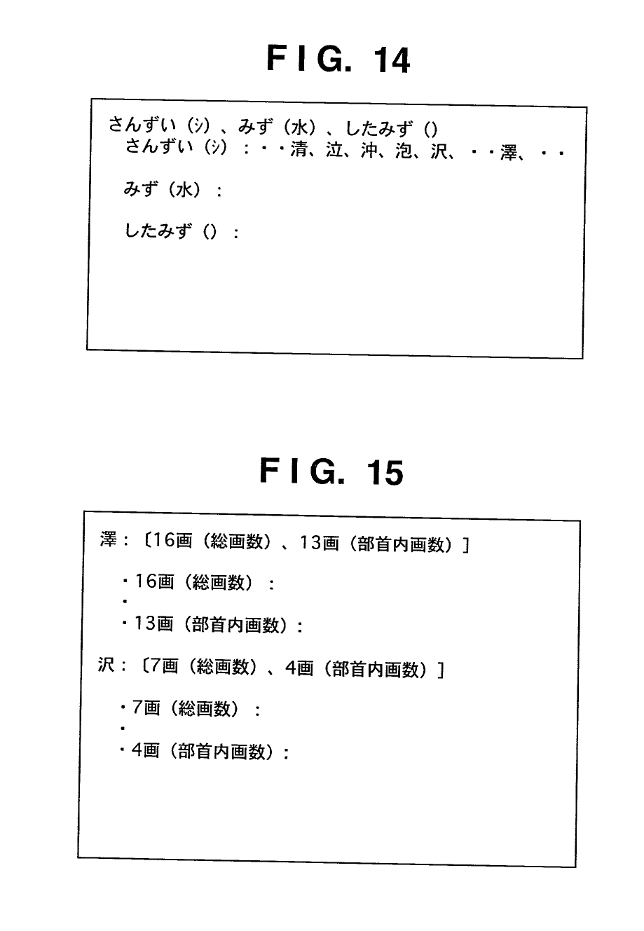

FIG. 11 shows a result of a search for characters relating to a specified code. FIG. 12 shows a result of a search for characters relating to a Chinese-style reading specified as an attribute. FIG. 13 shows a result of a search for characters relating to a Japanese-style reading specified as an attribute. FIG. 14 shows a result of a search for characters relating to a specified radical. FIG. 15 shows a result of a search for characters relating to the number of strokes specified as an attribute.

Thus, according to the present embodiment any character code can be translated into a unified character (kanji) representation, thereby facilitating document processing and management and improving the quality of the processing. Rather than limiting the use of the system to a particular organization, the system can be made available to a wide range of organizations such as local governments, educational institutions, and banking institutions, resulting in a good economic effect.

In addition, according to the present embodiment, the database of a management center can be passed over to the subsequent generations as a cultural inheritance.

As described above, according to the present embodiment, a search system for a dictionary database and a code system is constructed and allowed to be shared among users, thereby improving users' convenience. In addition, the constructed dictionary database can be open to the public through a network such as the Internet opened to the world, rather than being used in a closed network of a particular organization, thereby allowing the resources to be used effectively.

The search system for database of MJ letters that can represent any characters and the search system for character code systems is constructed on a server on the Internet and provided to a plurality of users, eliminating the need for computer manufacturers to provide fonts supporting all characters and therefore reduce the costs of a computer.

In addition, when a document is transferred from one computer to another, the sender of the document does not need to place restrictions on characters used for writing the document (for example prohibition of the use of external characters) and the receiver can use the search system for the character code systems to display or print the document properly.

While the present invention has been described with respect to the preferred embodiment, the present invention is not limited to the embodiment. Variations of the embodiments can be contemplated within the scope of the claims.

What is claimed is:

1. A system for providing a search service for searching a desired character to a plurality of users through a network, said system comprising:
a database storing character information corresponding to a plurality of characters;
means for retrieving search information about a search character to be searched sent from a user through a network;
address determination means for determining an address of a location in said database based on the retrieved search information; and
means for providing character information stored at the determined address of the location in said database through said network.

2. The system according to claim 1, wherein character information corresponding to any characters can be stored in any memory space of said database and the stored character is represented by a predetermined code.

3. The system according to claim 2, wherein said address determination means determines the address of the location of said database according to a predetermined code included in said search information.

4. The system according to claim 3, wherein said predetermined code is a code block including at least a country number, organization number, character number, relative address, MJ letter, and attribute code.

5. The system according to claim 1, wherein said providing means further provides character information about a character relating to said character to be searched if said character to be searched is a nonstandard character.

6. A search method for providing a search service for searching a desired character to a plurality of users through a network, said method comprising the steps of:
retrieving search information about a search character to be searched sent from a user through the network;
determining an address of a location in a database storing character information corresponding to a plurality of characters based on the retrieved search information; and
providing character information stored at the determined address of the location in said database through said network.

7. A program for search method in a system for providing a search service for searching a desired character to a plurality of users through a network, said program comprising codes for the steps of:
retrieving search information about a search character to be searched sent from a user through the network;
determining an address of a location in a database storing character information corresponding to a plurality of characters based on the retrieved search information; and
providing character information stored at the determined address of the location in said database through said network.

8. A computer-readable storage medium on which said program according to claim 7 is stored.
